(19) United States
(12) Patent Application Publication
(10) Pub. No.: US 2023/0361940 A1
(43) Pub. Date: Nov. 9, 2023

(54) SYSTEM AND METHODS FOR TRANSMISSION TIMING OPTIMIZATION

(71) Applicant: ZTE Corporation, Shenzhen (CN)

(72) Inventors: Huiying FANG, Shenzhen (CN); Bo DAI, Shenzhen (CN); Weiwei YANG, Shenzhen (CN); Youjun HU, Shenzhen (CN)

(73) Assignee: ZTE Corporation, Shenzhen (CN)

(21) Appl. No.: 18/351,964

(22) Filed: Jul. 13, 2023

Related U.S. Application Data
(63) Continuation of application No. PCT/CN2021/071975, filed on Jan. 15, 2021.

(51) Int. Cl. H04L 1/1829; H04W 72/12; H04L 5/00; H04W 72/0453; H04W 72/23

(52) U.S. Cl. CPC H04L 1/1854; H04W 72/12; H04L 5/0098; H04W 72/0453; H04W 72/23

(57) ABSTRACT

Methods and devices for wireless communication are provided. An indication of a bandwidth (BWP) switch is received at a wireless device from a network node. The indication of the BWP switch is used for switching the wireless device from a first bandwidth part to a second bandwidth part for communications between the wireless device and the network node. An effective scheduling delay is calculated by the wireless device as a sum of a scheduling delay and a delay offset. The delay offset is a time duration dedicated for the wireless device. The effective scheduling delay is used by the wireless device for a subsequent wireless data transmission between the network node and the wireless device.

### TECHNICAL FIELD

This patent document is directed generally to wireless communications.

### BACKGROUND

With the introduction of 5G wireless technologies, massive terminals are expected to meet the use cases of industrial wireless sensors, video surveillance, and consumer wearable devices. Accordingly, there is a need to optimize transmission timing of the user equipment (UE) and/or network nodes so that different types of user equipment (UE) devices, i e., those having reduced capabilities as well as legacy New Radio (NR) devices can be supported by 5G wireless technologies.

### SUMMARY

In one exemplary embodiment, a method for wireless communications includes receiving, at a wireless device, an indication of a bandwidth (BWP) switch in a message from a network node, wherein the indication of the BWP switch is used for switching the wireless device from a first bandwidth part to a second bandwidth part for communications between the wireless device and the network node; calculating, by the wireless device, an effective scheduling delay as a sum of a scheduling delay and a delay offset, wherein the delay offset is a time duration dedicated for the wireless device; and using, by the wireless device, the effective scheduling delay for a subsequent wireless data transmission between the network node and the wireless device.

In one exemplary embodiment, a method for wireless communications includes determining, at a network node, multiple sets of Hybrid Automatic Repeat Request Acknowledgement (HARQ-ACK) delays according to a plurality of values of scheduling delays such that at least a first set of HARQ-ACK delays is associated with a first value of scheduling delay and a second set of HARQ-ACK delays is associated with a second value of scheduling delay; selecting, by the network node, a HARQ-ACK delay from one of the multiple sets of HARQ-ACK delays based on a desired value of scheduling delay; transmitting, by the network node, the desired value of scheduling delay and the selected HARQ-ACK delay to a wireless device for a subsequent wireless transmission between the network node and the wireless device.

In one exemplary embodiment, a method for wireless communications includes transmitting, by a network node, an indication of a BWP switch in a message to a wireless device, wherein the indication of the BWP switch is used for switching the wireless device between a first bandwidth part and a second bandwidth part for communications between the wireless device and the network node; calculating, by the network node, an effective scheduling delay as a sum of a scheduling delay and a delay offset, wherein the delay offset is a time duration dedicated for a wireless device communicating with the network node; and scheduling, by the network node to the wireless device, a wireless data transmission using the effective scheduling delay.

In one exemplary embodiment, a method for wireless communications includes transmitting, by a network node, an indication of a bandwidth part (BWP) switch and a value of scheduling delay in a message to a wireless device, wherein the indication of the BWP switch is used for switching the wireless device between a first bandwidth part and a second bandwidth part for communications between the wireless device and the network node; wherein the value of the scheduling delay is greater than or equal to a value of a switch delay associated with the BWP switch; and wherein the value of the switch delay associated with the BWP switch is determined according to a frequency gap between the first bandwidth part and the second bandwidth part; and scheduling, by the network node to the wireless device, a wireless data transmission using the scheduling delay.

In one exemplary embodiment, a method for wireless communications includes an apparatus for wireless communication comprising a processor that is configured to carry out the method of any one or the clauses recited herein.

In one exemplary embodiment, a method for wireless communications includes a non-transitory, computer-readable medium having code stored thereon, the code, when executed by a processor, causing the processor to implement a method recited in any one or more of the clauses recited herein.

### BRIEF DESCRIPTION OF THE DRAWINGS

FIG. 1 illustrates an example SG network architecture.

FIG. 2 illustrates examples of bandwidth parts (BWPs).

FIG. 3 illustrates an example of transmission timing between a network node and a UE.

FIG. 4 illustrates an example of transmission timing between a network node and a UE using a BWP switching mechanism.

FIG. 5 illustrates an example of a frequency gap between two BWPs.

FIG. 6 illustrates another example of a frequency gap between two BWPs. FIG. 7A illustrates an example of HARQ-ACK bundling.

FIG. 7B illustrates another example of HARQ-ACK bundling.

FIG. 8 shows an example of a wireless communication system where techniques in accordance with one or more embodiments of the present technology can be applied.

FIG. 9 is a block diagram representation of a portion of a hardware platform.

FIG. 10 illustrates a flowchart of an example method associated with performing transmission timing optimization.

FIG. 11 illustrates a flowchart of an example method associated with performing transmission timing optimization.

FIG. 12 illustrates a flowchart of an example method associated with performing transmission timing optimization.

FIG. 13 illustrates a flowchart of an example method associated with performing transmission timing optimization.

### DETAILED DESCRIPTION

Section headings are used in the present document only for ease of understanding and do not limit the scope of the embodiments to the section in which they are described. Furthermore, while embodiments are described with reference to 5G examples, the disclosed techniques may be applied to wireless systems that use protocols other than 5G or 3GPP protocols.

The development of the new generation of wireless communication—5G New Radio (NR) communication—is part of a continuous mobile broadband evolution process to meet the requirements of increasing network demand. NR will provide greater throughput to allow more users to be connected at the same time. Other aspects, such as energy consumption, device cost, spectral efficiency, latency, and different types of UEs with different capabilities are important to meeting the needs of various communication scenarios.

### Overview

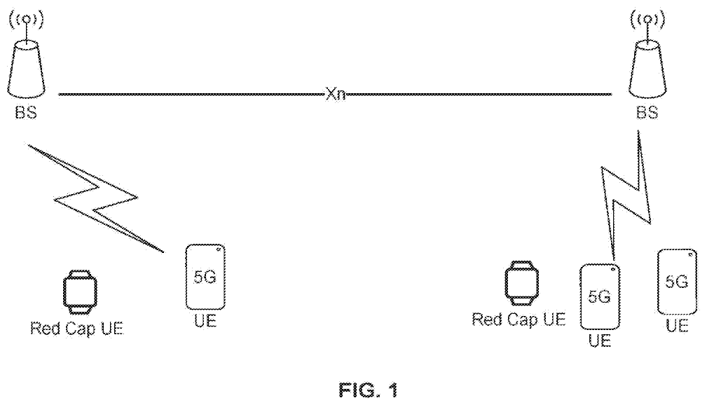

FIG. 1 shows a wireless communication system air interface representing a 5G structure. A 5G structure may include a 5G core network (5GC or 5G core) and a 5G access network. The 5G core network may include network elements relating to an access and mobility management unit (AMF), a user plane function (UPF), and a 5G access network that may include a network element 5G enhanced eNB base station (ng-eNB) or a 5G base station (gNB). The interface between the network element of the core network and the network element of the access network may include an NG interface, and the interface between the network elements of the access network may include an Xn interface. A RAN node can be a gNB (5G base station) providing New Radio (NR) user plane and control plane services. As another example, a RAN node can be an enhanced 4G eNodeB that connects to the 5G Core network via the NG interfaces but still uses 4G LTE air interface(s) to communicate with the 5G UE (alternatively referred to herein as wireless device).

In wireless communication systems, there may be different types of UE devices. Different types of UE may have different capabilities. For example, in a NR system, besides legacy NR UEs, reduced capability NR UEs can be present. Both legacy NR UEs and reduced capability NR UEs should be supported. Compared with legacy NR UEs, the maximum UE bandwidth for the reduced capability UEs is reduced from 100 MHz to 20 MHz in frequency range 1 (FR1) and from 200 MHz to 100 MHz in frequency range (FR2).

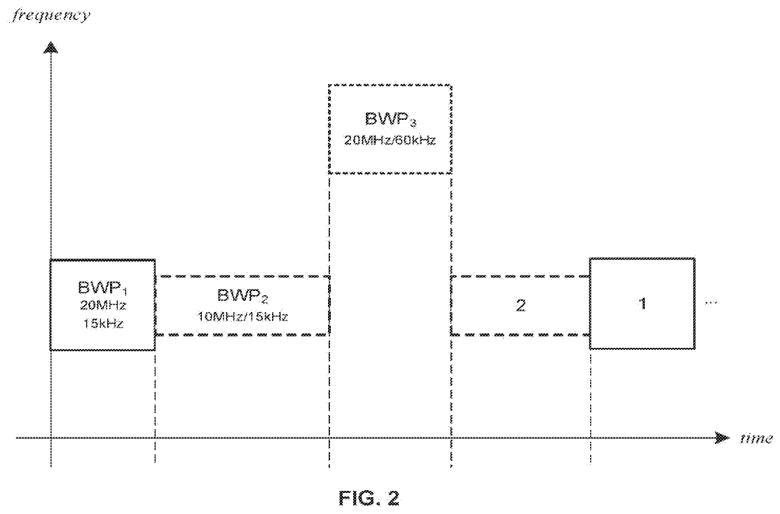

To support flexible scheduling and reduced UE power consumption, a bandwidth part (BWP) is introduced in a NR system. A BWP refers to a subset or a part of total carrier bandwidth. A BWP can form a set of contiguous common resource blocks (CRBs) within the full carrier bandwidth. While a UE can be configured to have BWPs for both uplink and downlink communications, there can only be one active BWP in the downlink and one in the uplink at a given time. When needed, the network can dynamically switch the UE to a desired BWP. For example, the network can impose BWP switching using RRC re-configuration. Alternatively, BWP switching can be controlled by the PDCCH indicating a downlink assignment or an uplink grant. FIG. 2 illustrates examples of bandwidth parts (BWPs).

In addition, for multiple hybrid automatic repeat request (HARQ) processes such as 14 HARQ processes, using same HARQ-ACK delay value set for all DL scheduling delay.

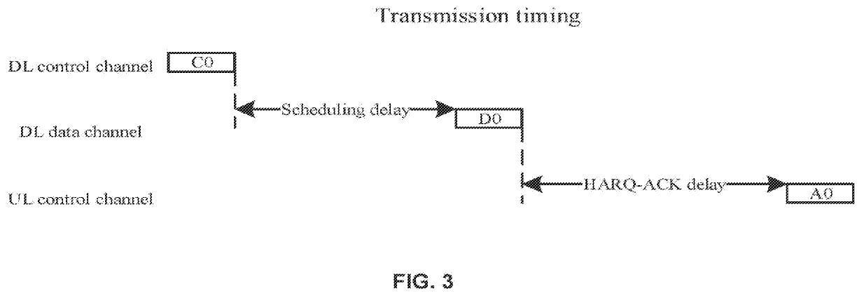

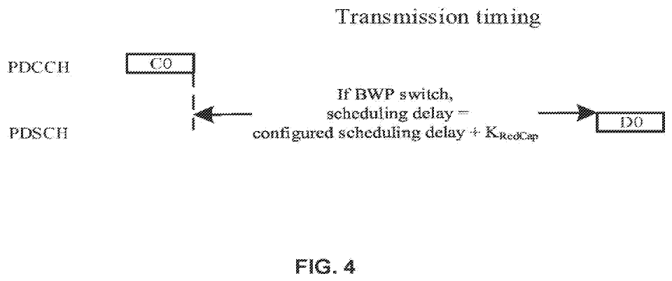

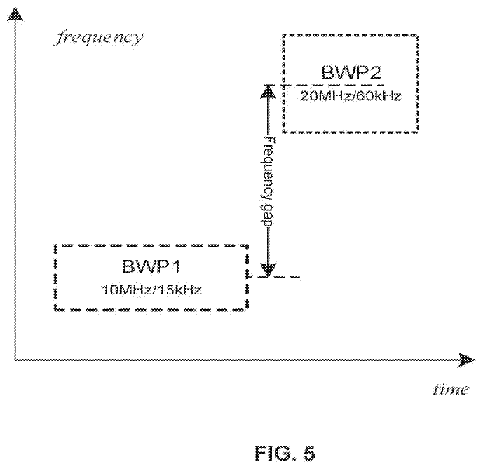

values cannot achieve the maximum peak data rate. Therefore, there is a need for optimizing transmission timings such as transmission scheduling delay and HARQ-ACK delay. FIG. 3 illustrates an example of transmission timing between a network node and a UE. In FIG. 4, CO denotes the downlink control channel index 0. DO denotes the downlink data channel index 0, and AO denotes the HARQ-ACK channel index 0.

For legacy NR UEs with large UE bandwidth capabilities, the UE bandwidth is large enough to decode the information of the whole system bandwidth. For such UEs, the BWP switch delay (defined as the time that a UE takes to switch from one BWP to another BWP) is mainly impacted by the adjustment of subcarrier spacing to the corresponding BWP. For reduced capability UEs, however, because the maximum UE bandwidth is reduced, the reduced capability UE can only decode the frequency region within its receiving capability. Thus, the UE is limited for operation only within its active BWP and not outside the active BWP. Accordingly, scheduling delays defined for legacy UEs may not be suitable for reduced capability UEs. For example, the reduced capability UE may need RF retuning during a BWP switch. That is, the RF retuning time needs to be considered for designing scheduling delays. The present technology is directed at designing a scheduling delay that include a RF retuning time duration.

### EXAMPLE EMBODIMENTS

Embodiments of the present technology are directed at designing a scheduling delay that include a RF retuning time duration. For example, such embodiments can be applicable to resolve the scheduling delay for reduced capability UEs due to RF retuning. By adding a delay offset to the scheduling delay, an effective scheduling delay value can be generated, which can be applicable to reduced capability UEs.

Additionally, embodiments of the present technology are directed at selecting different HARQ-ACK delay value sets for PDSCH scheduling delays, for multiple HARQ processes. That is, in accordance with disclosed embodiments, the HARQ-ACK delay value set is determined by the PDSCH scheduling delay.

At least one patentable benefit of the technology disclosed in this document is that invalid UL/DL subframes can be handled by adjusting (in a configurable manner) the set of HARQ-ACK delays. In addition, the embodiments disclosed herein are directed at maximizing resource utilization efficiency so that higher data rates can be achieved. In some embodiments, the same range of HARQ-ACK delays are supported for multiple HARQ processes (e.g., 0-13 HARQ processes) irrespective of the PDSCH scheduling delay. The PDSCH scheduling delay can be defined as the time duration between the start of PDSCH transmission and the end of MPDCCH transmission That is, irrespective of whether the PDSCH delay takes a first value (e.g., 2 subframes) or a second value (e.g., 7 subframes), the same range of HARQ-ACK delays are supported for multiple HARQ processes.

For example, the downlink data channel is scheduled by the downlink control channel and the HARQ ACK is transmitted by the uplink control channel to the base station (alternatively referred to herein as network node). To guarantee the timing alignment of base station and UE, a transmission timing is defined. The transmission timing includes the scheduling delay and the HARQ-ACK delay. In some examples, the scheduling delay is defined as the delay between the data channel and control channel. The HARQ-ACK delay is defined as the time period between the start of HARQ-ACK information transmission and the end of the receipt of DL data channel.

In the downlink (DL), after receiving the DL control channel in which the PDSCH is scheduled, the UE decodes the DL data channel in the time location according to the PDSCH scheduling delay. After the base station transmits the downlink control channel, the base station transmits the downlink data channel with a time delay of PDSCH scheduling delay. The value of the PDSCH scheduling delay is predefined (if predefined, there is no need to signal this value to the UE) or is sent to the UE in DCI carried in the downlink control channel. When the UE receives the DCI (besides the scheduling delay that may be included in the DCI, DCI also includes the time/frequency domain information of the PDSCH), the UE can determine the time location when the downlink data channel is transmitted. The UE can use the knowledge of the time location to decode the downlink channel.

In some implementations, the scheduling delay can be a predefined value, which is known a priori by the UE. Thus, in these implementations, the scheduling delay is not included in the DCI. In general, a scheduling delay (and/or a HARQ-ACK delay) can be a predefined value or can be dynamically signaled in the downlink control channel. If the scheduling delay is dynamically signaled, a value indicated in the downlink control channel is mapped to a fixed value.

On the other hand, the base station attempts to decode the HARQ-ACK feedback in the corresponding time location according to the HARQ-ACK delay. The value of the HARQ-ACK delay is sent from the base station to the UE in the DCI carried in the DL control channel. After the UE receives the DL data channel, the UE transmits (to the base station) the HARQ-ACK at the time location calculated based on the HARQ-ACK delay. The base station can use the knowledge of the time location to decode the HARQ-ACK information. In some implementations, the HARQ-ACK delay can be a predefined value, which is known a priori by the UE. Thus, in these implementations, the HARQ-ACK delay is not included in the DCI.

To support high data rates, a UE ought to be able to support multiple HARQ processes. The scheduling delay and the HARQ-ACK delay should be designed to achieve maximum peak data rate. In general, for multiple HARQ processes, in conventional technologies, the set of HARQ-ACK delay values for different DL scheduling delays are the same. But, having the same HARQ-ACK delay value for different scheduling delays can result in sub-optimal performance.

### Example Embodiment I (Dedicated Delay Offset)

FIG. 4 illustrates an example of transmission timing between a network node and a UE using a BWP switching mechanism. For reduced capability UEs, the reduced capability UE can interpret a delay offset value in a dedicated way. The delay offset can be representative of a reduced operational capability of the UE. A predefined delay offset (dedicated or specific to the UE) is added to the scheduling delay for BWP switch. The delay offset value (denoted KRedCap) can be in units of slots or symbols. Thus, the effective scheduling delay can be defined as a sum of a scheduling delay and a delay offset. In FIG. 4, C0 denotes the downlink control channel index 0 and DO denotes the downlink data channel index 0.

### Example Embodiment 2

In an NR system, when the reduced capability UE is scheduled to receive PDSCH by a DCI carried in PDCCH, if bandwidth part indicator field indicates BWP switch for the reduced capability UE, then the reduced capability UE adds an additional KRedCap slots or KRedCap symbols to the PDSCH scheduling delay. KRedCap can be a predefined offset value. Thus, the (effective) scheduling delay for the reduced capability equals the scheduling delay+KRedCap slots/symbols for BWP switch case, where the scheduling delay is determined by DCI and/or RRC signaling. The effective scheduling delay determines the starting time of a subsequent data transmission, i.e., a data packet between the base station and the UE.

### Example Embodiment 3

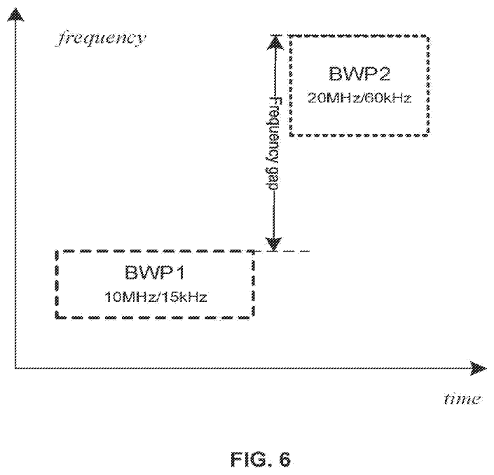

In an NR system, when the reduced capability UE is scheduled to receive PDSCH by a DCI carried in PDCCH, if a “bandwidth part indicator” field indicating BWP switch for the reduced capability UE is set, then the reduced capability UE assumes an additional KRedCap slots/symbols PDSCH scheduling delay. The (effective) scheduling delay for the reduced capability UE equals the scheduling delay+KRedCap slots/symbols for BWP switch case, where the scheduling delay is determined by DCI and/or RRC signaling. That is, the scheduling delay is carried in DCI to indicate the scheduling delay of PDSCH or PUSCH. KRedCap is determined according to the frequency gap between the two switching BWPs. FIG. 5 illustrates an example of a frequency gap between two BWPs (composed of a first BWP and a second BWP). The frequency gap in FIG. 5 is defined as a difference of center subcarrier frequencies in the first bandwidth part and the second bandwidth part. FIG. 6 illustrates another example of a frequency gap between two BWPs. The frequency gap in FIG. 6 is defined as a difference of highest subcarrier frequencies in the first bandwidth part and the second bandwidth part. In some embodiments, other definitions of frequency gap can be used. For example, the frequency gap can be defined as a difference of lowest subcarrier frequencies in the first bandwidth part and the second bandwidth part. In the examples provided below, different methods of selecting KRedCap are disclosed.

Example 1: One threshold is predefined. If the frequency gap is larger than the predefined threshold, KRedCap is equal to a predefined value (value A), otherwise, KRedCap is equal to another predefined value (value B), where value A>value B.

Example 2: Two thresholds are predefined (Threshold 1 and Threshold 2, where Threshold 2>Threshold 1). If the frequency gap is larger than Threshold 2, K_{RedCap} is equal to a predefined value (value A), else if the Threshold 1<frequency gap<=Threshold 2, KRedCap is equal to a predefined value (value B) otherwise. K_{RedCap} is equal to a predefined value (value C), where value A>value B>value C.

Example 3: A list of K_{RedCap} values corresponding to different frequency gap ranges are defined in a table. The value of K_{RedCap} is selected based on the fquency gap.

| Frequency gap range | Delay Offset (K_{RedCap)} |
|---|---|
| Frequency gap range A | Value 1 |
| Frequency gap range B | Value 2 |
| Frequency gap range C | Value 3 |
| Frequency gap range D | Value 4 |
| | Value N |

The frequency gap ranges and corresponding values of K_{RedCap} can be fixed beforehand or can be semi-statically configured by Radio Resource Control (RRC) signaling. This table can be available to the UE and/or the base station.

### Example Embodiment 4

In some embodiments, the scheduling delay (indicated in the DCI) is only handled by the base station and the UE directly applies the value of the scheduling delay. The base station can guarantee that the value of the scheduling delay is not smaller (e.g., greater than or equal to) than a value of the switch delay associated with the BWP switch. The switch delay associated with the BWP switch is the time duration when a UE switches from a first BWP to a second BWP. The base station transmits an indication of a BWP switch and a value of a scheduling delay in DCI to a UE. The indication of the BWP switch is used for switching the wireless device between a first bandwidth part and a second bandwidth part for communications between the wireless device and the network node. In some embodiments, the base station determines the value of the scheduling delay and provides a guarantee that the value of the scheduling delay is not smaller (e.g., greater than or equal to) than the value of the switch delay associated with the BWP switch by the wireless device. In some embodiments, the switch delay associated with the BWP switch is determined according to a frequency gap between the first bandwidth part and the second bandwidth part.

The frequency gap can be defined as one of the following: (i) a difference of center subcarrier frequencies in the first bandwidth part and the second bandwidth part, (ii) a difference of highest subcarrier frequencies in the first bandwidth part and the second bandwidth part, or (iii) a difference of lowest subcarrier frequencies in the first bandwidth part and the second bandwidth part. Further, in some implementations, the switch delay is set to a first value if the frequency gap is larger than a predefined threshold, and a second value otherwise. In some implementations, the switch delay is set to a first value if the frequency gap is larger than a second predefined threshold that is larger than a first predefined threshold, a second value if the frequency gap lies in between the first predefined threshold and a second predefined threshold, and a third value if the frequency gap is smaller than the first predefined threshold.

### Example Embodiment 5 (Dedicated HARO-ACK Delay Value Set)

For multiple HARQ processes, the dedicated HARQ-ACK delay value set(s) (i.e., comprising one or more sets of HARQ-ACK delay values) is defined for a given DL scheduling delay. For multiple HARQ processes, different HARQ-ACK delay value is set for different PDSCH scheduling delay values. A dedicated HARQ-ACK delay value can be set for 14 HARQ processes in the DL for an LTE-MTC system or a NB-IoT system. The base station has knowledge of the HARQ-ACK delay value set(s).

The HARQ-ACK delay value set for PDSCH scheduling delay of A is different from the HARQ-ACK delay value set for PDSCH scheduling delay of B, where A or B is a integer and A is different from B.

In an LTE-MTC system, PDSCH is scheduled in MPDCCH. For 14 HARQ processes, PDSCH scheduling delay can be 2 and 7 subframes. The HARQ-ACK delay value set for PDSCH scheduling delay of 2 subframes is different from the HARQ-ACK delay value set for PDSCH scheduling delay of 7 subframes. For example, for 14 HARQ processes:
1) The HARQ-ACK delay value set is {4, 5, 6, 7, 8, 9, 10, 11, 12, 13, 14, 15, 16, 17} for PDSCH scheduling delay of 2 subframes.
2) The HARQ-ACK delay value range is {12, 13, 14, 15, 16, 17, 18, 19} for PDSCH scheduling delay of 7 subframes.

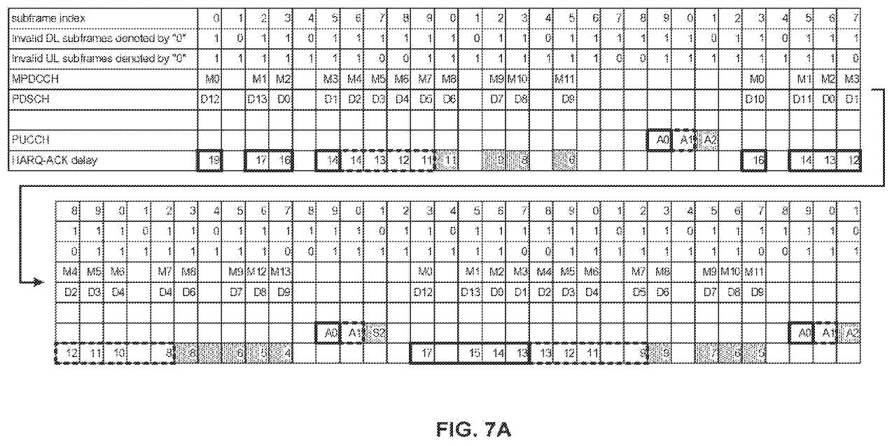

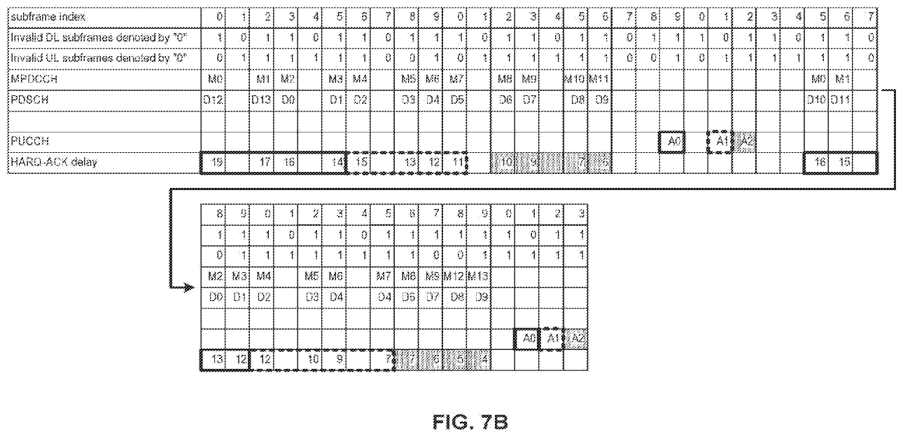

FIG. 7A shows an example of HARQ-ACK bundling applicable for 14 HARQ processes. In this example, the percentage of presence of invalid DL/UL subframes is 20%. HARQ-ACK bundling can enable sending HARQ-ACKs corresponding to multiple DL data processes over one UL channel. Multiple HARQ-ACKs can be bundled together and transmitted over one UL channel. Advantageously. HARQ-ACK bundling can improve the peak data rate. In the example shown, three (3) bundles are used to carry the HARQ-ACK information and up to 4 HARQ-ACKs are bundled together in each bundle. In FIG. 7A, different bundles are represented using boxes with different boundary lines and fill patterns. For PDSCH transmission DO to D9, the PDSCH scheduling delay is 2. The corresponding HARQ-ACK delay for PDSCH with scheduling delay of 2 subframes is within the HARQ-ACK value set {4, 5, 6, 7, 8, 9, 10, 11, 12, 13, 14, 15, 16, 17}. For PDSCH transmission D10 to D13, the PDSCH scheduling delay is 7. The corresponding HARQ-ACK delay value range is {12, 13, 14, 15, 16, 17, 18, 19} for PDSCH scheduling delay of 7. In some implementations, the HARQ-ACK delay and the value of scheduling delay can be configured separately from one another.

FIG. 7B shows another example of HARQ-ACK bundling applicable for 14 HARQ processes. In FIG. 7B, different bundles are represented using boxes with different boundary lines and fill patterns. In this example, the percentage of presence of invalid DL/UL subframes is 30%. For PDSCH transmission D0 to D9, the PDSCH scheduling delay is 2 subframes. The corresponding HARQ-ACK delay for PDSCH with scheduling delay of 2 is within the HARQ-ACK value set {4, 5, 6, 7, 8, 9, 10, 11, 12, 13, 14, 15, 16, 17}. For PDSCH transmission D10 to D13, the PDSCH scheduling delay is 7 subframes. The corresponding HARQ-ACK delay value range is {12, 13, 14, 15, 16, 17, 18, 19} for a PDSCH scheduling delay of 7

### System Implementations

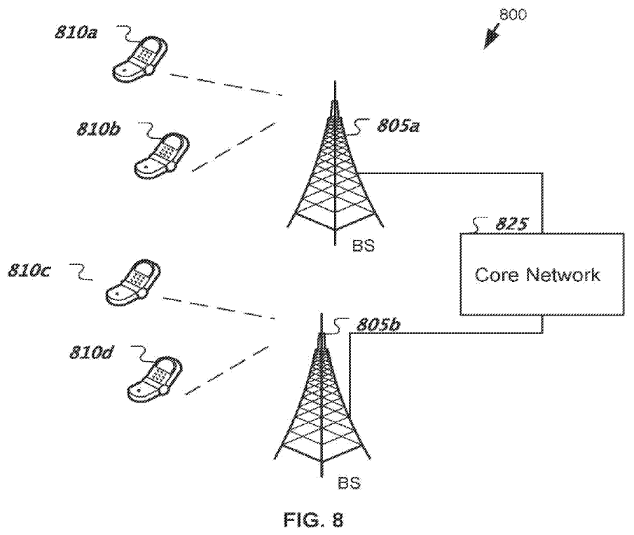

FIG. 8 shows an example of a wireless communication system where techniques in accordance with one or more embodiments of the present technology can be applied. A wireless communication system 800 can include one or more base stations (BSs) 805a, 805b, one or more wireless devices 810a, 810b. 810c, 810d, and a core network 825. A base station 805a, 805b can provide wireless service to wireless devices 810a, 810b, 810c, and 810d in one or more wireless sectors. In some implementations, a base station 805a. 805b includes directional antennas to produce two or more directional beams to provide wireless coverage in different sectors.

The core network 825 can communicate with one or more base stations 805a, 805b. The core network 825 provides connectivity with other wireless communication systems and wired communication systems. The core network may include one or more service subscription databases to store information related to the subscribed wireless devices 810a, 810b, 810c, and 810d. A first base station 805a can provide wireless service based on a first radio access technology, whereas a second base station 805b can provide wireless service based on a second radio access technology. The base stations 805a and 805b may be co-located or may be separately installed in the field according to the deployment scenario. The wireless devices 810a, 810b, 810c, and 810d can support multiple different radio access technologies. In some embodiments, the base stations 805a, 805b may be configured to implement some techniques described in the present document. The wireless devices 810a to 810d may be configured to implement some techniques described in the present document.

In some implementations, a wireless communication system can include multiple networks using different wireless technologies. A dual-mode or multi-mode wireless device includes two or more wireless technologies that could be used to connect to different wireless networks.

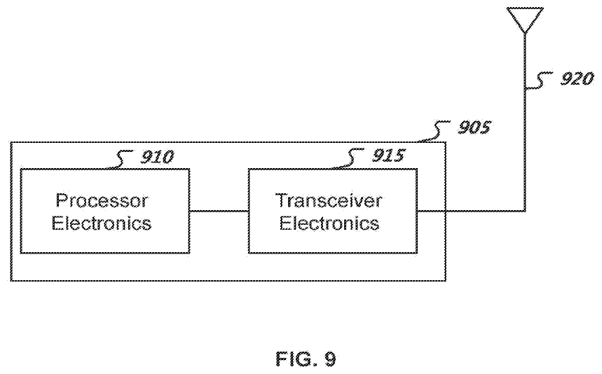

FIG. 9 is a block diagram representation of a portion of a hardware platform. A hardware platform 905 such as a network node or a base station or a wireless device (or UE) can include processor electronics 910 such as a microprocessor that implements one or more of the techniques presented in this document. The hardware platform 905 can include transceiver electronics 915 to send and/or receive wired or wireless signals over one or more communication interfaces such as antenna 920 or a wireline interface. The hardware platform 905 can implement other communication interfaces with defined protocols for transmitting and receiving data. The hardware platform 905 can include one or more memories (not explicitly shown) configured to store information such as data and/or instructions. In some implementations, the processor electronics 910 can include at least a portion of the transceiver electronics 915. In some embodiments, at least some of the disclosed techniques, modules or functions, a central node, a distributed node, a terminal or network nodes are implemented using the hardware platform 905.

Some embodiments of the present document are now presented in clause-based format.

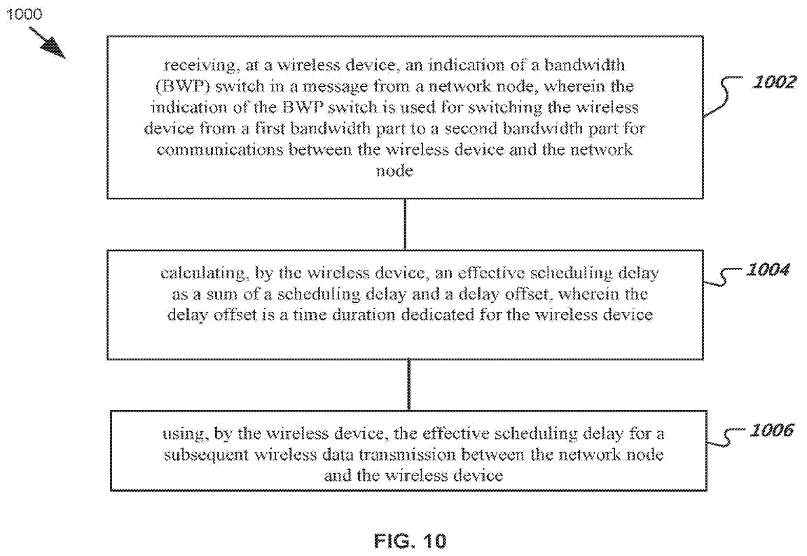

A1. A method (e.g., as shown in FIG. 10) for wireless communications comprising receiving (step 1002), at a wireless device, an indication of a bandwidth part (BWP) switch in a message from a network node, wherein the indication of the BWP switch is used for switching the wireless device from a first bandwidth part to a second bandwidth part for communications between the wireless device and the network node;
calculating (step 1004), by the wireless device, an effective scheduling delay as a sum of a scheduling delay and a delay offset, wherein the delay offset is a time duration dedicated for the wireless device; and
using (step 1006), by the wireless device, the effective scheduling delay for a subsequent wireless data transmission between the network node and the wireless device.

A2. The method of clause A1, wherein the delay offset is determined according to a frequency gap between the first bandwidth part and the second bandwidth part.

A3. The method of clause A2, wherein the frequency gap is defined as a difference of center subcarrier frequencies in the first bandwidth part and the second bandwidth part.

A4. The method of clause A2, wherein the frequency gap is defined as a difference of highest subcarrier frequencies in the first bandwidth part and the second bandwidth part.

A5. The method of clause A2, wherein the frequency gap is defined as a difference of lowest subcarrier frequencies in the first bandwidth part and the second bandwidth part.

A6. The method of clause A2, wherein the delay offset is a first value if the frequency gap is larger than a predefined threshold, and a second value otherwise.

A7. The method of clause A2, wherein the delay offset is a first value if the frequency gap is larger than a second predefined threshold that is larger than a first predefined threshold, a second value if the frequency gap lies in between the first predefined threshold and a second predefined threshold, and a third value if the frequency gap is smaller than the first predefined threshold.

A8. The method of clause A1, wherein the delay offset is in units of slots or symbols.

A9. The method of clause A1, wherein the scheduling delay is a predefined value or semi-statically configured in a Radio Resource Control (RRC) message or dynamically signaled in a downlink control channel between the wireless device and the network node.

A10. The method of clause A1, wherein the message is a Downlink Control Information (DCI) to signal a scheduling of a Physical Downlink Shared Channel (PDSCH) or a Physical Downlink Shared Channel (PDSCH).

A11. The method of clause A10, wherein the BWP switch is indicated in a bandwidth part indicator field included in the Downlink DCI.

A12. The method of clause A1, wherein the subsequent wireless communication between the wireless device and the network node includes the wireless device receiving a data packet from the network node.

A13. The method of clause A1, wherein the subsequent wireless communication between the wireless device and the network node includes the wireless device transmitting a data packet to the network node.

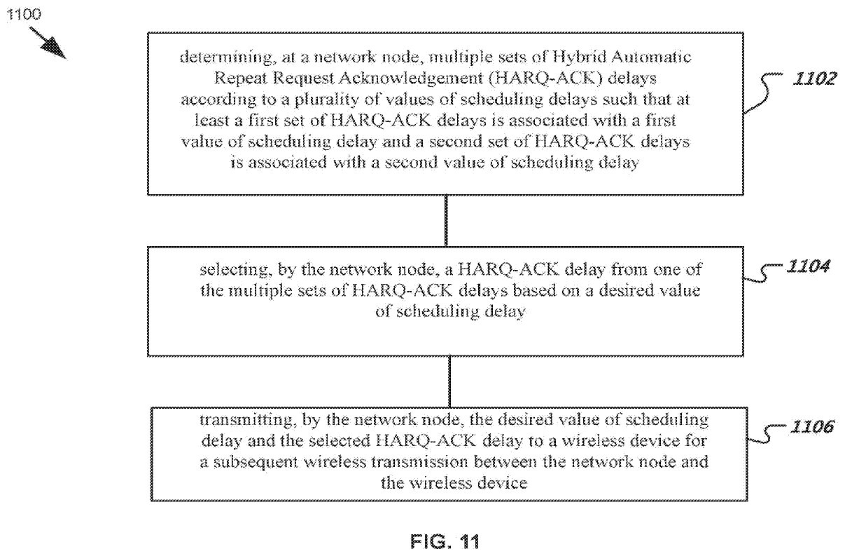

B1. A method (e.g., as shown in FIG. 11) for wireless communications comprising:
determining (step 1102), at a network node, multiple sets of Hybrid Automatic Repeat Request Acknowledgement (HARQ-ACK) delays according to a plurality of values of scheduling delays such that at least a first set of HARQ-ACK delays is associated with a first value of scheduling delay and a second set of HARQ-ACK delays is associated with a second value of scheduling delay;
selecting (step 1104), by the network node, a HARQ-ACK delay from one of the multiple sets of HARQ-ACK delays based on a desired value of scheduling delay;
transmitting (step 1106), by the network node, the desired value of scheduling delay and the selected HARQ-ACK delay to a wireless device for a subsequent wireless transmission between the network node and the wireless device.

B2. The method of clause B1, wherein the first set of HARQ-ACK delays is different from the second set of HARQ-ACK delays if the first value of scheduling delay and the second value of scheduling delay are different.

B3. The method of clause B1, wherein the first value of scheduling delay and the second value of scheduling delay correspond to 2 subframes and 7 subframes.

B4. The method of clause B2, wherein the first set of HARQ-ACK delays is expressed as {4, 5, 6, 7, 8, 9, 10, 11, 12, 13, 14, 15, 16, 17} and the second set of HARQ-ACK delays is expressed as {12, 13, 14, 15, 16, 17, 18, 19}.

B5. The method of clause B1, wherein the value of scheduling delay and the value of HARQ-ACK delay is carried in a Downlink Control Information (DCI) message to signal a Machine Type Communication Physical Downlink Control Channel (MPDCCH).

B6. The method of clause B1, wherein the multiple sets of HARQ-ACK delays correspond to fourteen (14) HARQ processes included in an LTE machine type communication (MTC) system.

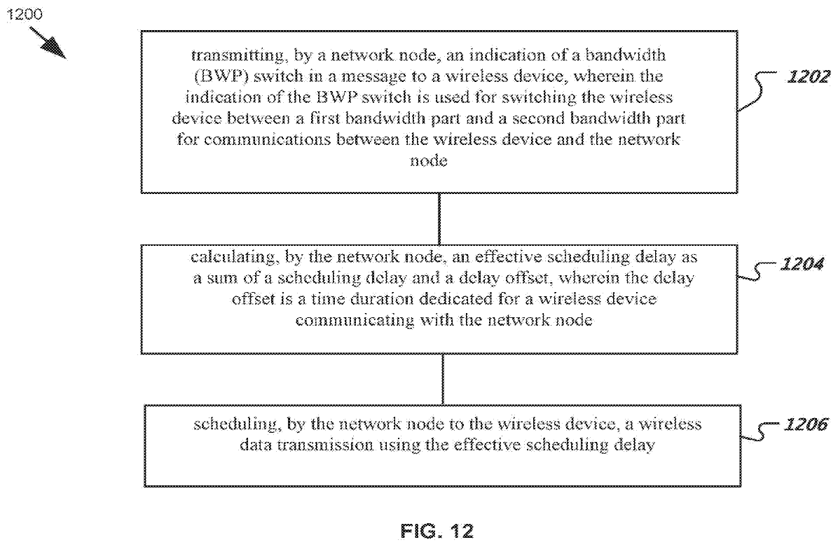

C1. A method (e.g., as shown in FIG. 12) for wireless communications comprising:
transmitting. by a network node, an indication of a bandwidth part (BWP) switch in a message to a wireless device, wherein the indication of the BWP switch is used for switching the wireless device between a first bandwidth part and a second bandwidth part for communications between the wireless device and the network node;
calculating, by the network node, an effective scheduling delay as a sum of a scheduling delay and a delay offset, wherein the delay offset is a time duration dedicated for a wireless device communicating with the network node; and
scheduling, by the network node to the wireless device, a wireless data transmission using the effective scheduling delay.

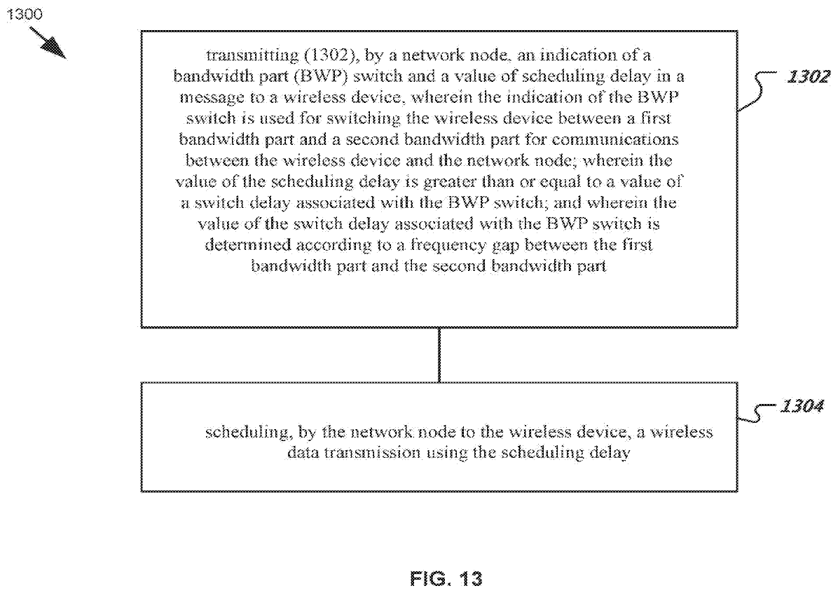

D1. A method (e.g., as shown in FIG. 13) for wireless communications comprising:
transmitting (1302), by a network node, an indication of a bandwidth part (BWP) switch and a value of scheduling delay in a message to a wireless device, wherein the indication of the BWP switch is used for switching the wireless device between a first bandwidth part and a second bandwidth part for communications between the wireless device and the network node; wherein the value of the scheduling delay is greater than or equal to a value of a switch delay associated with the BWP switch; and wherein the value of the switch delay associated with the BWP switch is determined according to a frequency gap between the first bandwidth part and the second bandwidth part; and
scheduling (1304), by the network node to the wireless device, a wireless data transmission using the scheduling delay.

D2. The method of claim D1, wherein the frequency gap is defined as a difference of center subcarrier frequencies in the first bandwidth part and the second bandwidth part.

D3. The method of claim D1, wherein the frequency gap is defined as a difference of highest subcarrier frequencies in the first bandwidth part and the second bandwidth part.

D4. The method of claim D1, wherein the frequency gap is defined as a difference of lowest subcarrier frequencies in the first bandwidth part and the second bandwidth part.

D5. The method of claim D1, wherein the value of the switch delay is a first value if the frequency gap is larger than a predefined threshold, and a second value otherwise.

D6. The method of claim D1, wherein the value of the switch delay is a first value if the frequency gap is larger than a second predefined threshold that is larger than a first predefined threshold, a second value if the frequency gap lies in between the first predefined threshold and a second predefined threshold, and a third value if the frequency gap is smaller than the first predefined threshold.

E1. An apparatus for wireless communication comprising a processor that is configured to carry out the method of any one or more of afore-mentioned clauses.

F1. A non-transitory, computer-readable medium having code stored thereon, the code, when executed by a processor, causing the processor to implement a method recited in any one or more of the afore-mentioned clauses.

The full names of several acronyms used in this document are provided below.

| Acronym | Full Name |
|---|---|
| 5G | Fifth Generation |
| 5GC | 5G Core network |
| AMF | Access Mobility Function |
| SMF | Session Management Function |
| UPF | User Plane Function |
| CN | Core network |
| 5QI | 5G QoS Identifier |
| QoS | Quality of Service |
| LIE | Long Term Evolution |
| NR | New Radio |
| BWP | Bandwidth part |
| FRI | Frequency range 1 |
| FR2 | Frequency range 2 |
| RedCap | Reduced capability |
| DCI | Downlink Control Information |
| PDSCH | Physical Downlink Shared Channel |
| PDCCH | Physical Downlink Control Channel |
| MPDCCH | MTC Physical Downlink |
| | Control Channel |
| HARQ | Hybrid Automatic Repeat Request |
| ACK | Acknowledgement |
| RRC | Radio Resource Control |

The disclosed and other embodiments, modules, and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, that is, one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, for example, code that constitutes processor firmware, a protocol stack, a database management system, an operating system, or a combination of one or more of them. A propagated signal is an artificially generated signal, for example, a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, for example, an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, for example, magnetic, magneto-optical disks, or optical discs. However, a computer need not have such devices. Computer-readable media suitable for storing computer program instructions and data include all forms of non-volatile memory, media and memory devices, including by way of example semiconductor memory devices, for example, EPROM, EEPROM, and flash memory devices; magnetic disks, for example, internal hard disks or removable disks; magneto-optical disks; and CD-ROM and DVD-ROM discs. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements, and variations can be made based on what is described and illustrated in this patent document.

From the foregoing, it will be appreciated that specific embodiments of the presently disclosed technology have been described herein for purposes of illustration, but that various modifications may be made without deviating from the scope of the invention. Accordingly, the presently disclosed technology is not limited except as by the appended clauses.

1-23. (canceled)

24. A method for wireless communications comprising:
receiving, at a wireless device, an indication of a bandwidth part (BWP) switch in a message from a network node, wherein
the indication of the BWP switch is used for switching the wireless device from a first bandwidth part to a second bandwidth part for communications between the wireless device and the network node;
calculating, by the wireless device, an effective scheduling delay as a sum of a scheduling delay and a delay offset, wherein
the delay offset is a time duration dedicated for the wireless device; and
using, by the wireless device, the effective scheduling delay for a subsequent wireless data transmission between the network node and the wireless device.

25. The method of claim 24, wherein the delay offset is determined according to a frequency gap between the first bandwidth part and the second bandwidth part.

26. The method of claim 25, wherein the frequency gap is defined as a difference of center subcarrier frequencies in the first bandwidth part and the second bandwidth part.

27. The method of claim 25, wherein the frequency gap is defined as a difference of highest subcarrier frequencies in the first bandwidth part and the second bandwidth part.

28. The method of claim 25, wherein the frequency gap is defined as a difference of lowest subcarrier frequencies in the first bandwidth part and the second bandwidth part.

29. The method of claim 25, wherein the delay offset is a first value if the frequency gap is larger than a predefined threshold, and a second value otherwise.

30. The method of claim 25, wherein the delay offset is a first value if the frequency gap is larger than a second predefined threshold that is larger than a first predefined threshold, a second value if the frequency gap lies in between the first predefined threshold and a second predefined threshold, and a third value if the frequency gap is smaller than the first predefined threshold.

31. The method of claim 24, wherein the delay offset is in units of slots or symbols.

32. The method of claim 24, wherein the scheduling delay is a predefined value or semi-statically configured in a Radio Resource Control (RRC) message or dynamically signaled in a downlink control channel between the wireless device and the network node.

33. The method of claim 24, wherein the message is a Downlink Control Information (DCI) to signal a scheduling of a Physical Downlink Shared Channel (PDSCH) or a Physical Downlink Shared Channel (PDSCH).

34. The method of claim 33, wherein the BWP switch is indicated in a bandwidth part indicator field included in the Downlink DCI.

35. The method of claim 24, wherein the subsequent wireless data transmission between the wireless device and the network node includes the wireless device receiving a data packet from the network node.

36. The method of claim 24, wherein the subsequent wireless data transmission between the wireless device and the network node includes the wireless device transmitting a data packet to the network node.

37. A method for wireless communications comprising:
determining, at a network node, multiple sets of Hybrid Automatic Repeat Request Acknowledgement (HARQ-ACK) delays according to a plurality of values of scheduling delays such that at least a first set of HARQ-ACK delays is associated with a first value of a scheduling delay and a second set of HARQ-ACK delays is associated with a second value of a scheduling delay;
selecting, by the network node, a HARQ-ACK delay from one of the multiple sets of HARQ-ACK delays based on a desired value of a scheduling delay; and
transmitting, by the network node, the desired value of a scheduling delay and the selected HARQ-ACK delay to a wireless device for a subsequent wireless transmission between the network node and the wireless device.

38. The method of claim 37, wherein the first set of HARQ-ACK delays is different from the second set of HARQ-ACK delays if the first value of a scheduling delay and the second value of the scheduling delay are different.

39. The method of claim 37, wherein the first value of a scheduling delay and the second value of the scheduling delay correspond to 2 subframes and 7 subframes.

40. The method of claim 38, wherein the first set of HARQ-ACK delays is expressed as {4, 5, 6, 7, 8, 9, 10, 11, 12, 13, 14, 15, 16, 17} and the second set of HARQ-ACK delays is expressed as {12, 13, 14, 15, 16, 17, 18, 19}.

41. The method of claim 37, wherein the value of the scheduling delay and the value of HARQ-ACK delay is carried in a Downlink Control Information (DCI) message to signal a Machine Type Communication Physical Downlink Control Channel (MPDCCH).

42. The method of claim 37, wherein the multiple sets of HARQ-ACK delays correspond to fourteen HARQ processes included in an LTE machine type communication (MTC) system.

43. A method for wireless communications comprising:
transmitting, by a network node, an indication of a bandwidth part (BWP) switch and a value of a scheduling delay in a message to a wireless device, wherein
the indication of the BWP switch is used for switching the wireless device between a first bandwidth part and a second bandwidth part for communications between the wireless device and the network node,
the value of the scheduling delay is greater than or equal to a value of a switch delay associated with the BWP switch, and
the value of the switch delay associated with the BWP switch is determined according to a frequency gap between the first bandwidth part and the second bandwidth part; and
scheduling, by the network node to the wireless device, a wireless data transmission using the scheduling delay.
